(19) United States
(12) Patent Application Publication
(10) Pub. No.: US 2025/0299052 A1
(43) Pub. Date: Sep. 25, 2025

(54) LARGE MODEL-BASED TEXT GENERATION METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Zhaojing ZHOU, Beijing (CN); Minghao LI, Beijing (CN); Feisheng WU, Beijing (CN); Haoshuang WANG, Beijing (CN); Qingqing DANG, Beijing (CN); Yanlin SHA, Beijing (CN); Dianhai YU, Beijing (CN); Yanjun MA, Beijing (CN); Tian WU, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 19/231,279

(22) Filed: Jun. 6, 2025

(30) Foreign Application Priority Data
Dec. 17, 2024 (CN) 202411865296.3

(51) Int. Cl. G06N 3/09; G06F 40/284; G06F 40/40; G06N 3/0475

(52) U.S. Cl. CPC G06N 3/09; G06F 40/284; G06F 40/40; G06N 3/0475

(57) ABSTRACT

A large model-based text generation method, electronic device, and storage medium in the field of artificial intelligence technologies such as large models and natural language processing are provided. The specific implementation includes: obtaining a matching prefix, where the matching prefix includes at least one consecutive token; obtaining a draft token sequence based on the matching prefix according to a pre-configured draft token sequence length, where the draft token sequence includes at least one token; performing validity verification on the draft token sequence using a pre-trained large model based on a speculative decoding algorithm; and in response to passing the verification, using the draft token sequence as generated text.

### CROSS-REFERENCE TO RELATED APPLICATION

The present disclosure claims the priority and benefit of Chinese Patent Application No. 202411865296.3, filed on Dec. 17, 2024, entitled “Large Model-based Text Generation Method, Apparatus, Electronic Device and Storage Medium”. The disclosure of the above application is incorporated herein by reference in its entirety.

### TECHNICAL FIELD

The present disclosure relates to the field of computer technology, particularly to the field of artificial intelligence technologies such as large models and natural language processing, and more particularly to a large model-based text generation method, electronic device and storage medium.

### BACKGROUND

Large models are deep learning models with enormous parameter scales and highly complex structures, typically referring to neural network models with hundreds of millions to billions of parameters.

In the prior art, large models have achieved significant results in a series of downstream tasks. They provide many convenient services and assistance for human life through real-time human-computer interaction.

### SUMMARY

The present disclosure provides a large model-based text generation method, electronic device and storage medium.

According to one aspect of the present disclosure, a large model-based text generation method is provided, including:
obtaining a matching prefix, where the matching prefix includes at least one consecutive token;
obtaining a draft token sequence based on the matching prefix according to a pre-configured draft token sequence length, where the draft token sequence includes at least one token;
performing validity verification on the draft token sequence using a pre-trained large model based on a speculative decoding algorithm; and
in response to passing the verification, using the draft token sequence as generated text.

According to a further aspect of the present disclosure, an electronic device is provided, including:
at least one processor; and
a memory communicatively connected to the at least one processor;
where the memory stores instructions executable by the at least one processor, and the instructions, when executed by the at least one processor, cause the at least one processor to perform the method as described above and any possible implementation thereof.

According to yet another aspect of the present disclosure, a non-transitory computer-readable storage medium storing computer instructions is provided, where the computer instructions are used to cause a computer to perform the method as described above and any possible implementation thereof.

It should be understood that the content described in this section is not intended to identify key or essential features of the embodiments of the present disclosure, nor is it intended to limit the scope of the present disclosure. Other features of the present disclosure will become readily understandable through the following specification.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure; and

FIG. 6 is a block diagram of an electronic device for implementing the method of the embodiments of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications may be made with respect to the embodiments described herein without departing from the scope and spirit of the present disclosure. Similarly, for clarity and conciseness, the descriptions of the known functions and structures are omitted in the descriptions below.

Obviously, the described embodiments are some but not all of the embodiments of the present disclosure. Based on these embodiments, all other embodiments obtained by those skilled in the art without creative effort fall within the protection scope of the present disclosure.

It should be noted that the terminal devices involved in the embodiments of the present disclosure may include but are not limited to smartphones, Personal Digital Assistants (PDAs), wireless handheld devices, Tablet Computers and other smart devices; display devices may include but are not limited to personal computers, televisions and other devices with display functionality.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

Currently, the high inference latency of large models has become a major obstacle to their wider application. The increase in inference latency of large models is not only due to their enormous parameter count and high computational cost but mainly stems from their autoregressive decoding generation method, which requires generating tokens one by one, causing inference latency to continuously increase with the length of the generated sequence.

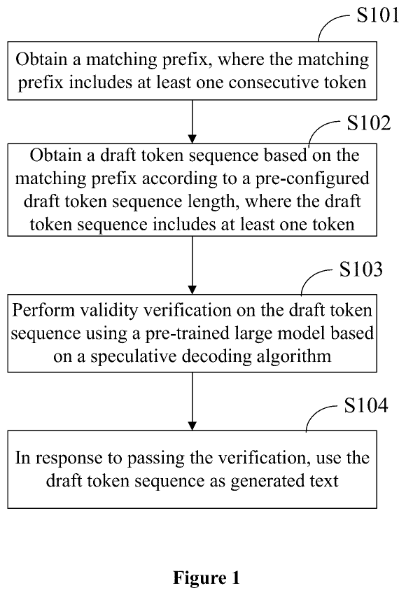

FIG. 1 is a schematic diagram according to a first embodiment of the present disclosure. As shown in FIG. 1, this embodiment provides a large model-based text generation method, which specifically includes the following steps:

S101: Obtain a matching prefix, where the matching prefix includes at least one consecutive token;

S102: Obtain a draft token sequence based on the matching prefix according to a pre-configured draft token sequence length, where the draft token sequence includes at least one token;

The large model-based text generation method of this embodiment is applied in scenarios of generating text based on large models. The executing subject of this method is a large model-based text generation apparatus, which may be an electronic entity, or may be implemented as software applications or intelligent agents that can generate text based on large models.

In this embodiment, the matching prefix is the basis for obtaining the draft token sequence. The draft token sequence includes at least one token, and when it includes two or more tokens, the sequence itself also defines the order of these tokens. The matching prefix may also be considered as a token sequence containing at least one consecutive token. The tokens in this embodiment may be understood as word units. The token units in this embodiment may be at character granularity or word granularity, which may be set according to specific scenarios or requirements without limitation.

In this embodiment, the pre-configured draft token sequence length is used to limit the number of tokens included in the draft token sequence.

In this embodiment, the draft token sequence is matched based on the matching prefix rather than being generated by the model, which can improve the efficiency of obtaining the draft token sequence.

S103: Perform validity verification on the draft token sequence using a pre-trained large model based on a speculative decoding algorithm;

S104: In response to passing the verification, use the draft token sequence as generated text.

Since the draft token sequence may be matched based on the matching prefix and truncated according to the pre-configured draft token sequence length, it cannot be directly used as a generated text without validity verification using the pre-trained large model. Therefore, in this embodiment, the large model does not need to use autoregressive decoding to generate each token in the draft token sequence, it only needs to verify the validity of each token in the draft token sequence.

When the draft token sequence includes two or more tokens, during the verification process using the speculative decoding algorithm, the validity of two or more tokens may be verified in parallel, which can further improve efficiency.

Additionally, optionally, in practical application scenarios, if the draft token sequence fails verification, it cannot be used as the text generated by the large model.

The large model-based text generation method of this embodiment can effectively improve the efficiency of obtaining draft token sequences by obtaining a matching prefix and obtaining draft token sequences according to a pre-configured draft token sequence length. Furthermore, by using the large model based on speculative decoding algorithm to verify the validity of draft token sequences, the draft token sequences may be used as generated text after verification. In this technical solution, the large model does not need to use autoregressive decoding to generate text, but only needs to verify the validity of the matched draft token sequences. Compared with generating text using autoregressive decoding, this can effectively reduce the time consumed in text generation and improve text generation efficiency.

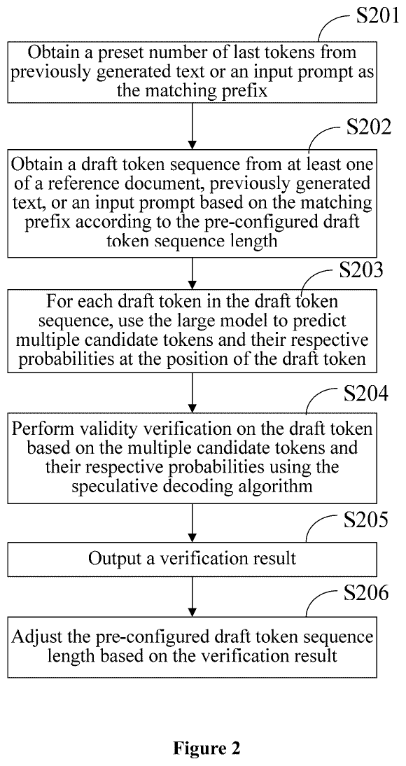

FIG. 2 is a schematic diagram according to a second embodiment of the present disclosure. This embodiment of the large model-based text generation method, based on the technical solution shown in FIG. 1, provides a more detailed description of the technical solution. As shown in FIG. 2, this embodiment specifically includes the following steps:

S201: Obtain a preset number of last tokens from previously generated text or an input prompt as the matching prefix;

S202: Obtain a draft token sequence from at least one of a reference document, previously generated text, or an input prompt based on the matching prefix according to the pre-configured draft token sequence length;

In text generation scenarios such as text summarization, multi-round dialogue, and retrieval augmentation, there is often high phrase repetition between the large model's generation results and input information. This embodiment may utilize this information repetition to obtain draft token sequences.

Specifically, large model text generation is not completed in one step but through multiple iterations. When the large model generates text for the first time, the model's input information only includes the input prompt. In this case, the matching prefix may be obtained from the input prompt by taking the last preset number of tokens. For non-first-time text generation, the model's input information may include both the input prompt and a previously generated text. Specifically, the input prompt and the previously generated text may be concatenated as input information for the large model. In this case, the matching prefix may be obtained from the last preset number of tokens in the previously generated text.

In this embodiment, obtaining the matching prefix from the previously generated text or the input prompt is very accurate and efficient.

Then, the same matching prefix is searched in the preceding text, and upon successful matching, the segment following the matching prefix with the draft token sequence length is taken as the draft token sequence. The preceding text in this embodiment may also be called above text, which may include the previously generated text or the input prompt (Prompt). If the input information includes a reference document, the preceding text may also include the reference document. Based on this, the draft token sequence may be obtained from the reference document, the previously generated text, or the input prompt according to the pre-configured draft token sequence length based on the matching prefix.

In this embodiment, obtaining a draft token sequence from the reference document, the previously generated text, or the input prompt provides effective support for accurate acquisition of the draft token sequence.

To improve matching success rate and draft token sequence effectiveness, this embodiment proposes a priority-based matching algorithm. Prefix matching search for the draft token sequence may be performed preferentially in the previously generated text. When the search fails in the previously generated text, searching and matching continues in the input prompt. In retrieval augmentation scenarios where reference document content is included in the input prompt, priority will be given to searching and matching in the reference document. In other words, the pre-configured priority strategy may be: the reference document>the previously generated text>the input prompt, meaning the reference document has the highest priority and the input prompt has the lowest. This priority strategy not only ensures matching success rate but also improves draft token sequence quality, potentially increasing subsequent verification pass rates.

S203: For each draft token in the draft token sequence, use the large model to predict multiple candidate tokens and their respective probabilities at the position of the draft token;

S204: Perform validity verification on the draft token based on the multiple candidate tokens and their respective probabilities using the speculative decoding algorithm;

For each draft token in the draft token sequence, verification in steps S203 and S204 may be performed by the large model based on the speculative decoding algorithm. Specifically, verification may be performed on multiple draft tokens in parallel. That is, predicting multiple candidate tokens and their respective probabilities for all draft token's positions in parallel, and performing validity verification on multiple draft tokens in parallel based on the predicted information.

Specifically, when predicting candidate tokens and their probabilities for the position of each draft token, the prediction may be based on the preceding text of that draft token. For example, the preceding text may include input information and draft tokens before the current draft token in the sequence. If the draft token is the first draft token in the sequence, the corresponding preceding text may include the input information which is concatenated from the input prompt and previously generated text. For first-time text generation with no previously generated text yet, the preceding text may only include the input prompt.

In this embodiment, when performing validity verification on draft tokens based on multiple candidate tokens and their respective probabilities, the speculative decoding algorithm may be used. Specifically, step S204 may include the following steps:
(1) Sort the multiple candidate tokens based on their respective probabilities to obtain a first sorting; and
(2) Perform validity verification on the draft token using the speculative decoding algorithm based on the first sorting.

For example, step (2) may be implemented in two ways:

First Implementation Method, which may be abbreviated as the top N verification method:

Specifically, detect whether the draft token is among top N tokens with highest probabilities in the first sorting, where N is a positive integer. N may be set to 1, 2, or other values according to requirements, without limitation. If yes, determine the draft token as valid, meaning it passes verification.

In this embodiment, when verifying each draft token in the draft token sequence, to ensure the draft token sequence is the same as tokens obtained by large model using the autoregressive decoding, N may be set to 1 in top N verification (i.e., top 1verification). This means verification only passes when the draft token matches the highest probability token generated by the large model. While this strict verification strategy ensures consistency between speculative decoding and autoregressive decoding results, it lead to resource waste.

For example, in a retrieval augmentation scenario, suppose the original large model performs parallel verification on 6 draft tokens obtained from a reference document with prefix searching and matching. If only one draft token fails verification, even though subsequent draft tokens in the sequence could pass verification, they are discarded due to the earlier failure. Such cases are common under strict verification strategies. To avoid wasting draft tokens, the top N verification method may be used. That is, the draft token passes verification if it ranks among the top N candidates predicted by the large model for that position.

This approach can effectively improve the verification pass rate of draft tokens, thereby enhancing the acceleration effect of speculative decoding and improving text generation efficiency.

Second Implementation Method, which may be abbreviated as the top P verification method:

Specifically, based on the first sorting, calculate the cumulative sum of the probability of the draft token and the probabilities of candidate tokens with higher probabilities. For example, if the first sorting is arranged in descending order of probability, first determine a target sorting identifier of the draft token in the first sorting, then calculate the cumulative sum of probabilities for all candidate tokens up to (and including) that target sorting identifier. Then check if the cumulative sum reaches a preset probability value, such as p. If yes, determine the draft token as valid. In this embodiment, P may be set according to actual needs, such as 0.95, 0.9, or 0.85, without limitation.

This approach can also effectively improve the verification pass rate of draft tokens, enhancing the acceleration effect of speculative decoding and improving text generation efficiency.

S205: Output a verification result;

For example, the verification results may include draft tokens that passed verification.

Specifically, based on the verification in steps S203 and S204, determine the draft tokens that passed verification, obtain and output the corresponding verification result.

S206: Adjust the pre-configured draft token sequence length based on the verification result.

Considering that the verification pass rate of speculative decoding is also affected by the length of the draft token sequence being verified (i.e., the number of draft tokens included), when the number of draft tokens is too small, the number of acquired draft tokens each time is limited; when the number of draft tokens is too large, the time cost for parallel decoding by the large model is increased. Both cases affect the actual acceleration benefits of speculative decoding.

Based on the above considerations, this embodiment may dynamically adjust the draft token sequence length, specifically including:
(a) If all draft tokens in the sequence pass verification, increase the pre-configured draft token sequence length; for example, add 1, 2, or other values to the current pre-configured length, without limitation.
(b) If only some draft tokens in the sequence pass verification, decrease the pre-configured draft token sequence length; for example, subtract 1, 2, or other values from the current pre-configured length, without limitation.

Through the above methods, the draft token sequence length may be dynamically adjusted based on each verification result, which may effectively improve the efficiency of each verification, reduce the time consumption of parallel decoding by the large model, and thereby effectively improve text generation efficiency.

In this embodiment, when the draft token sequence verification fails, meaning not all draft tokens in the sequence pass verification, the large model uses autoregressive decoding method to generate text, ensuring the text generation functionality.

The large model-based text generation method of this embodiment can effectively reduce the time required to obtain draft token sequences and improve their acquisition efficiency through search matching strategies, reducing the cost of using speculative decoding. Meanwhile, the top N or top P verification methods can effectively improve the verification pass rate of draft tokens, ultimately enhancing the acceleration effect of speculative decoding and improving the text generation efficiency of large models.

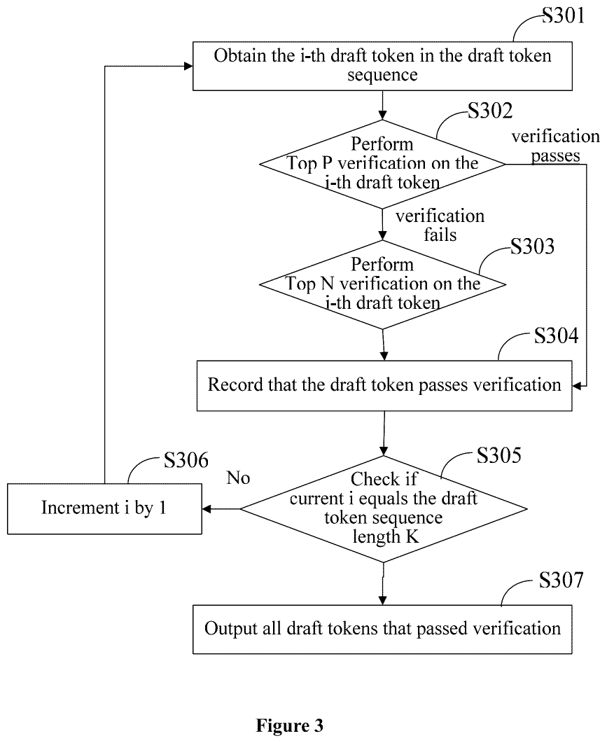

FIG. 3 is a schematic diagram according to a third embodiment of the present disclosure. Based on the embodiment shown in FIG. 2, this embodiment combines top N and top P verification methods to verify the draft token sequence, specifically including the following steps:

S301: Obtain the i-th draft token in the draft token sequence; proceed to step S302;

During specific verification, take the i-th draft token sequentially from front to back. The minimum value of i is 1, and the maximum value is the length of the draft token sequence, denoted as K in this embodiment. Initially, start with i=1.

S302: Perform Top P verification on the i-th draft token; if verification fails, proceed to step S303; if verification passes, proceed to step S304;

Refer to the Top P verification implementation described in the embodiment shown in FIG. 2. Top P verification means the draft token passes if it is in the token set with cumulative probability exceeding value p in large model decoding.

S303: Perform Top N verification on the i-th draft token; if verification passes, proceed to step S304; if verification fails, proceed to step S305;

S304: Record that the draft token passes verification; proceed to step S305;

Refer to the Top N verification implementation described in the embodiment shown in FIG. 2. Top N verification means the draft token passes if it appears in the top N tokens ranked by probability in large model decoding.

S305: Check if current i equals the draft token sequence length K; if not equal, proceed to step S306; if equal, proceed to step S307;

S306: Increment i by 1; return to step S301 to continue verification;

S307: Output all draft tokens that passed verification, end.

The output result of this embodiment may further indicate whether all draft tokens in the sequence passed verification.

The draft token verification in this embodiment combines two verification methods to implement draft token sequence verification based on soft matching windows, which can effectively improve the verification pass rate of draft tokens, enhance the acceleration effect of speculative decoding, and thereby effectively improve the efficiency of large model text generation.

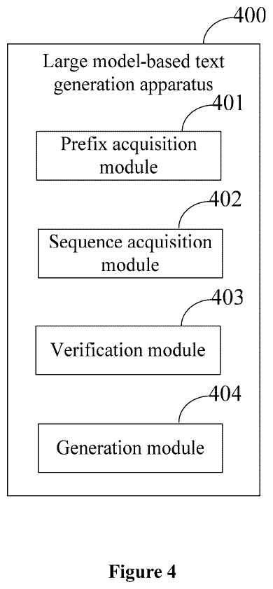

FIG. 4 is a schematic diagram according to a fourth embodiment of the present disclosure. As shown in FIG. 4, this embodiment provides a large model-based text generation apparatus 400, including:

Prefix acquisition module 401, configured to obtain a matching prefix, where the matching prefix includes at least one consecutive token;

Sequence acquisition module 402, configured to obtain a draft token sequence based on the matching prefix according to a pre-configured draft token sequence length, where the draft token sequence includes at least one token;

Verification module 403, configured to perform validity verification on the draft token sequence using a pre-trained large model based on a speculative decoding algorithm;

Generation module 404, configured to use the draft token sequence as generated text in response to passing the verification.

The implementation principles and technical effects of the large model-based text generation apparatus 400 in this embodiment are the same as those described in the above-related method embodiments, which may be referred to for details without further elaboration here.

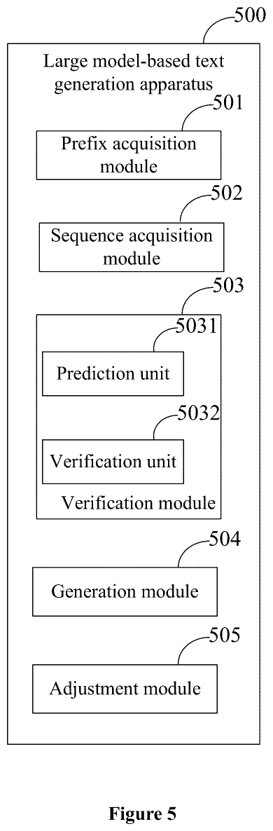

FIG. 5 is a schematic diagram according to a fifth embodiment of the present disclosure. As shown in FIG. 5, the large model-based text generation apparatus 500 of this embodiment, based on the technical solution shown in FIG. 4, provides a more detailed description of the technical solution. The apparatus 500 includes the same modules with the same functions as shown in FIG. 4: prefix acquisition module 501, sequence acquisition module 502, verification module 503, and generation module 504.

In this embodiment, the prefix acquisition module 501 is configured to:

Obtain a preset number of last tokens from previously generated text or an input prompt as the matching prefix.

Optionally, in one embodiment of the present disclosure, the sequence acquisition module 502 is configured to:

Obtain the draft token sequence from a reference document, previously generated text, or an input prompt based on the matching prefix according to the pre-configured draft token sequence length.

Optionally, in one embodiment, the sequence acquisition module 502 is configured to:

Obtain the draft token sequence from the reference document, the previously generated text, or the input prompt based on the matching prefix according to a pre-configured priority strategy and the pre-configured draft token sequence length.

Optionally, as shown in FIG. 5, in one embodiment of the present disclosure, the verification module 503 includes:

Prediction unit 5031, configured to use the large model to predict multiple candidate tokens and their respective probabilities at the position of each draft token in the draft token sequence;

Verification unit 5032, configured to perform validity verification on the draft token based on the multiple candidate tokens and their respective probabilities using the speculative decoding algorithm.

Optionally, in one embodiment, the verification unit 5032 is configured to:

Sort the multiple candidate tokens based on their respective probabilities to obtain a first sorting; and

Perform validity verification on the draft token based on the first sorting using the speculative decoding algorithm.

Optionally, in one embodiment of the present disclosure, the verification unit 5032 is configured to:

Detect whether the draft token is among top N tokens with highest probabilities in the first sorting, where N is a positive integer;

Determine that the draft token as valid if yes.

Optionally, in one embodiment of the present disclosure, the verification unit 5032 is configured to:

Obtain a cumulative sum of probabilities of the draft token and candidate tokens having higher probabilities than the draft token based on the first sorting;

Detect whether the cumulative sum reaches a preset probability value;

Determine that the draft token as valid if yes.

Optionally, as shown in FIG. 5, in one embodiment of the present disclosure, the large model-based text generation apparatus 500 further includes:

Adjustment module 505, configured to adjust the pre-configured draft token sequence length based on a verification result.

Optionally, in one embodiment of the present disclosure, the adjustment module 505 is configured to:

Increase the pre-configured draft token sequence length if all draft tokens in the sequence pass verification;

Decrease the pre-configured draft token sequence length if only some draft tokens in the sequence pass verification.

The implementation principles and technical effects of the large model-based text generation apparatus 500 in this embodiment are the same as those described in the above-related method embodiments, which may be referred to for details without further elaboration here.

In the technical solution of the present disclosure, the acquisition, storage, and application of user personal information comply with relevant laws and regulations and do not violate public order and good morals.

According to the embodiments of the present disclosure, an electronic device, a readable storage medium, and a computer program product are also provided.

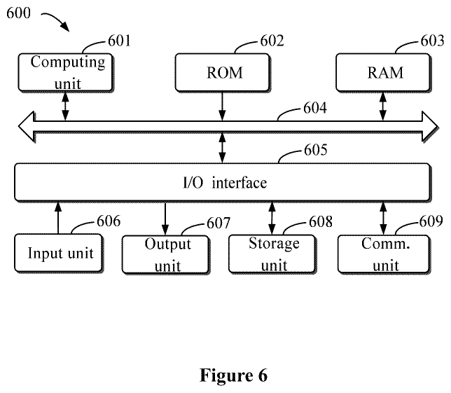

FIG. 6 shows a schematic block diagram of an example electronic device 600 that may be used to implement embodiments of the present disclosure. The electronic device is intended to represent various forms of digital computers, such as laptops, desktops, workstations, personal digital assistants, servers, blade servers, mainframes, and other suitable computers. The electronic device may also represent various forms of mobile devices, such as personal digital processors, cellular phones, smartphones, wearable devices, and other similar computing devices. The components shown here, their connections and relationships, and their functions are meant as examples only and are not intended to limit implementations of the disclosure described and/or claimed in this document.

As shown in FIG. 6, device 600 includes a computing unit 601, which may execute various appropriate actions and processes according to computer programs stored in Read-Only Memory (ROM) 602 or loaded into Random Access Memory (RAM) 603 from storage unit 608. RAM 603 may also store various programs and data needed for device 600′s operation. Computing unit 601, ROM 602, and RAM 603 are interconnected via bus 604. Input/Output (I/O) interface 605 is also connected to bus 604.

Multiple components in device 600 are connected to I/O interface 605, including: input unit 606, such as keyboard, mouse, etc.; output unit 607, such as various types of displays, speakers, etc.; storage unit 608, such as magnetic disks, optical disks, etc.; and communication unit 609, such as network cards, modems, wireless communication transceivers, etc. Communication unit 609 allows device 600 to exchange information/data with other devices through computer networks such as the Internet and/or various telecommunications networks.

Computing unit 601 may be various general-purpose and/or specialized processing components with processing and computing capabilities. Some examples of computing unit 601 include but are not limited to Central Processing Units (CPU), Graphics Processing Units (GPU), various specialized Artificial Intelligence (AI) computing chips, various computing units running machine learning model algorithms, Digital Signal Processors (DSP), and any appropriate processors, controllers, microcontrollers, etc. Computing unit 601 executes the various methods and processes described above, such as the methods of the present disclosure. For example, in some embodiments, the methods of the present disclosure may be implemented as computer software programs tangibly contained in machine-readable media, such as storage unit 608. In some embodiments, part or all of the computer programs may be loaded and/or installed onto device 600 via ROM 602 and/or communication (comm.) unit 609. When the computer programs are loaded into RAM 603 and executed by computing unit 601, one or more steps of the methods of the present disclosure described above may be executed. Alternatively, in other embodiments, computing unit 601 may be configured to execute the methods of the present disclosure through any other appropriate means (e.g., through firmware).

Various implementations of the systems and techniques described in this document may be realized in digital electronic circuitry systems, integrated circuit systems, Field Programmable Gate Arrays (FPGA), Application Specific Integrated Circuits (ASIC), Application Specific Standard Products (ASSP), System on Chip (SOC), Complex Programmable Logic Devices (CPLD), computer hardware, firmware, software, and/or combinations thereof. These various implementations may include implementation in one or more computer programs that are executable and/or interpretable on a programmable system including at least one programmable processor, which may be special or general purpose, capable of receiving data and instructions from, and transmitting data and instructions to, a storage system, at least one input device, and at least one output device.

Program code for implementing the methods of the present disclosure may be written in any combination of one or more programming languages. These program codes may be provided to processors or controllers of general-purpose computers, special-purpose computers, or other programmable data processing apparatus, such that the program codes, when executed by the processor or controller, cause the functions/operations specified in the flowcharts and/or block diagrams to be implemented. The program code may execute entirely on the machine, partly on the machine, partly on the machine as a standalone software package and partly on a remote machine, or entirely on the remote machine or server.

In the context of the present disclosure, machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus, or devices, or any suitable combination thereof. More specific examples of machine-readable storage media would include an electrical connection based on one or more wires, a portable computer diskette, a hard disk, Random Access Memory (RAM), Read-Only Memory (ROM), Erasable Programmable Read-Only Memory (EPROM or flash memory), optical fiber, Portable Compact Disc Read-Only Memory (CD-ROM), optical storage devices, magnetic storage devices, or any suitable combination thereof.

To provide interaction with a user, the systems and techniques described herein may be implemented on a computer having a display device (e.g., CRT (Cathode Ray Tube) or LCD (Liquid Crystal Display) monitor) for displaying information to the user, and a keyboard and pointing device (e.g., mouse or trackball) through which the user may provide input to the computer. Other kinds of devices may be used to provide interaction with users; for example, feedback provided to the user may be any form of sensory feedback (e.g., visual feedback, auditory feedback, or tactile feedback); and input from the user may be received in any form, including acoustic, speech, or tactile input.

The systems and techniques described herein may be implemented in a computing system that includes a back-end component (e.g., as a data server), or a middleware component (e.g., an application server), or a front-end component (e.g., a user computer having a graphical user interface or a web browser through which a user may interact with an implementation of the systems and techniques described here), or any combination of such back-end, middleware, or front-end components. The components of the system may be interconnected by any form or medium of digital data communication (e.g., a communication network). Examples of communication networks include a Local Area Network (LAN), Wide Area Network (WAN), and the Internet.

The computer system may include clients and servers. A client and server are generally remote from each other and typically interact through a communication network. The relationship of client and server arises by virtue of computer programs running on the respective computers and having a client-server relationship to each other. The server may be a cloud server, a server of a distributed system, or a server incorporating blockchain technology.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A large model-based text generation method, comprising:
obtaining a matching prefix, wherein the matching prefix comprises at least one consecutive token;
obtaining a draft token sequence based on the matching prefix according to a pre-configured draft token sequence length, wherein the draft token sequence comprises at least one token;
performing validity verification on the draft token sequence using a pre-trained large model based on a speculative decoding algorithm; and
in response to passing the verification, using the draft token sequence as generated text.

2. The method according to claim 1, wherein obtaining the matching prefix comprises:
obtaining a preset number of last tokens from previously generated text or an input prompt as the matching prefix.

3. The method according to claim 1, wherein obtaining the draft token sequence based on the matching prefix according to the pre-configured draft token sequence length comprises:
obtaining the draft token sequence from a reference document, previously generated text, or an input prompt based on the matching prefix according to the pre-configured draft token sequence length.

4. The method according to claim 3, wherein obtaining the draft token sequence from the reference document, the previously generated text, or the input prompt based on the matching prefix according to the pre-configured draft token sequence length comprises:
obtaining the draft token sequence from the reference document, the previously generated text, or the input prompt based on the matching prefix according to a pre-configured priority strategy and the pre-configured draft token sequence length.

5. The method according to claim 1, wherein performing validity verification on the draft token sequence using the pre-trained large model based on the speculative decoding algorithm comprises:
for each draft token in the draft token sequence, using the large model to predict multiple candidate tokens and their respective probabilities at the position of the draft token;
performing validity verification on the draft token based on the multiple candidate tokens and their respective probabilities using the speculative decoding algorithm.

6. The method according to claim 5, wherein performing validity verification on the draft token based on the multiple candidate tokens and their respective probabilities using the speculative decoding algorithm comprises:
sorting the multiple candidate tokens based on their respective probabilities to obtain a first sorting; and
performing validity verification on the draft token based on the first sorting using the speculative decoding algorithm.

7. The method according to claim 6, wherein performing validity verification on the draft token based on the first sorting using the speculative decoding algorithm comprises:
detecting whether the draft token is among top N tokens with highest probabilities in the first sorting, wherein N is a positive integer;
if the draft token is among top N tokens with highest probabilities in the first sorting, determining that the draft token is valid.

8. The method according to claim 6, wherein performing validity verification on the draft token based on the first sorting using the speculative decoding algorithm comprises:
obtaining a cumulative sum of probabilities of the draft token and candidate tokens having higher probabilities than the draft token based on the first sorting;
detecting whether the cumulative sum reaches a preset probability value;
if the cumulative sum reaches the preset probability value, determining that the draft token is valid.

9. The method according to claim 6, wherein performing validity verification on the draft token based on the first sorting using the speculative decoding algorithm comprises:
obtaining a cumulative sum of probabilities of the draft token and candidate tokens having higher probabilities than the draft token based on the first sorting;
detecting whether the cumulative sum reaches a preset probability value;
in response to the cumulative sum being equal to or greater than the preset probability value, determining that the draft token is valid,
in response to the cumulative sum being less than the preset probability value, determining that the draft token is not valid, and detecting whether the draft token is among top N tokens with highest probabilities in the first sorting, wherein Nis equal to or greater than two; if the draft token is among top N tokens with highest probabilities in the first sorting, determining that the draft token is valid.

10. The method according to claim 6, wherein after performing validity verification on the draft token sequence using the pre-trained large model based on the speculative decoding algorithm, the method further comprises:
adjusting the pre-configured draft token sequence length based on a verification result.

11. The method according to claim 10, wherein adjusting the pre-configured draft token sequence length based on the verification result comprises:
increasing the pre-configured draft token sequence length if all draft tokens in the draft token sequence pass verification;
decreasing the pre-configured draft token sequence length if only some draft tokens in the draft token sequence pass verification.

12. An electronic device, comprising:
at least one processor; and
a memory communicatively connected to the at least one processor;
wherein the memory stores instructions executable by the at least one processor, and the instructions, when executed by the at least one processor, cause the at least one processor to perform a large model-based text generation method, comprising:
obtaining a matching prefix, wherein the matching prefix comprises at least one consecutive token;
obtaining a draft token sequence based on the matching prefix according to a pre-configured draft token sequence length, wherein the draft token sequence comprises at least one token;
performing validity verification on the draft token sequence using a pre-trained large model based on a speculative decoding algorithm; and
in response to passing the verification, using the draft token sequence as generated text.

13. The electronic device according to claim 12, wherein obtaining the matching prefix comprises:
obtaining a preset number of last tokens from previously generated text or an input prompt as the matching prefix.

14. The electronic device according to claim 12, wherein obtaining the draft token sequence based on the matching prefix according to the pre-configured draft token sequence length comprises:
obtaining the draft token sequence from a reference document, previously generated text, or an input prompt based on the matching prefix according to the pre-configured draft token sequence length.

15. The electronic device according to claim 12, wherein performing validity verification on the draft token sequence using the pre-trained large model based on the speculative decoding algorithm comprises:
for each draft token in the draft token sequence, using the large model to predict multiple candidate tokens and their respective probabilities at the position of the draft token;
performing validity verification on the draft token based on the multiple candidate tokens and their respective probabilities using the speculative decoding algorithm.

16. The electronic device according to claim 15, wherein performing validity verification on the draft token based on the multiple candidate tokens and their respective probabilities using the speculative decoding algorithm comprises:
sorting the multiple candidate tokens based on their respective probabilities to obtain a first sorting; and
performing validity verification on the draft token based on the first sorting using the speculative decoding algorithm.

17. The electronic device according to claim 16, wherein performing validity verification on the draft token based on the first sorting using the speculative decoding algorithm comprises:
detecting whether the draft token is among top N tokens with highest probabilities in the first sorting, wherein N is a positive integer;
if the draft token is among top N tokens with highest probabilities in the first sorting, determining that the draft token is valid.

18. The electronic device according to claim 16, wherein performing validity verification on the draft token based on the first sorting using the speculative decoding algorithm comprises:
obtaining a cumulative sum of probabilities of the draft token and candidate tokens having higher probabilities than the draft token based on the first sorting;
detecting whether the cumulative sum reaches a preset probability value;
if the cumulative sum reaches the preset probability value, determining that the draft token is valid.

19. The electronic device according to claim 16, wherein after performing validity verification on the draft token sequence using the pre-trained large model based on the speculative decoding algorithm, the method further comprises:
adjusting the pre-configured draft token sequence length based on a verification result.

20. A non-transitory computer-readable storage medium storing computer instructions for causing a computer to perform a large model-based text generation method, comprising:
obtaining a matching prefix, wherein the matching prefix comprises at least one consecutive token;
obtaining a draft token sequence based on the matching prefix according to a pre-configured draft token sequence length, wherein the draft token sequence comprises at least one token;
performing validity verification on the draft token sequence using a pre-trained large model based on a speculative decoding algorithm; and
in response to passing the verification, using the draft token sequence as generated text.
